(19) United States
(12) Patent Application Publication
(10) Pub. No.: US 2013/0155349 A1
(43) Pub. Date: Jun. 20, 2013

(54) LIQUID CRYSTAL DISPLAY

(71) Applicant: Sheng-Pai HUANG, Hsin-Chu (TW)

(72) Inventor: Sheng-Pai HUANG, Hsin-Chu (TW)

(73) Assignee: AU Optronics Corporation, Hsin-Chu (TW)

(21) Appl. No.: 13/474,827

(22) Filed: May 18, 2012

(30) Foreign Application Priority Data
Dec. 14, 2011 (TW) 100146281

(51) Int. Cl. G02F 1/1335

(52) U.S. Cl. 349/60; 349/106; 349/58; 349/96

(57) ABSTRACT

A liquid crystal display is disclosed. The liquid crystal display includes a backlight module, a liquid crystal panel, a printed circuit board, and a flexible printed circuit board. The liquid crystal panel is disposed on the backlight module. The liquid crystal panel includes a thin film transistor substrate and a color filter. The color filter faces the backlight module, and the thin film transistor substrate has a bonding area. The flexible printed circuit board connects the bonding area to the printed circuit board.

### RELATED APPLICATIONS

This application claims priority to Taiwan Application Serial Number 100146281, filed Dec. 14, 2011, which is herein incorporated by reference.

### BACKGROUND

1. Field of Invention

The present invention relates to a display. More particularly, the present invention relates to a liquid crystal display.

2. Description of Related Art

Liquid crystal displays (LCDs) have been widely used in electrical products in recent times due to the rapid progress of optical technology and semiconductor technology. Moreover, with the advantages of high image quality, compact size, light weight, low driving voltage, and low power consumption, LCDs have been introduced into portable computers, personal digital assistants, and color televisions, and are gradually replacing the cathode ray tubes (CRTs) used in conventional displays. As a result, the LCD has become the most widely used display apparatus.

An LCD includes the main elements of a frame, a liquid crystal panel, a printed circuit board, and a backlight module. The liquid crystal panel connects to the printed circuit board via a flexible printed circuit board. Liquid crystal displays are becoming lighter and thinner. In addition, the frame width of liquid crystal displays is getting smaller and smaller, and even a frameless design is utilized in some liquid crystal displays.

As shown in FIG. 1, in a conventional liquid crystal display with a frameless design, a flexible printed circuit board 110 connects a thin film transistor substrate 120 of a liquid crystal panel to a printed circuit board 130. A frame 140 is close to the thin film transistor substrate 120 due to the frameless design. Furthermore, the flexible printed circuit board 110 wraps around the thin film transistor substrate 120 and is tightly interposed between the frame 140 and the thin film transistor substrate 120, such that the flexible printed circuit board 110 rubs against the frame 140 and the thin film transistor substrate 120. This may result in damage to the wires on the flexible printed circuit board 110.

### SUMMARY

An embodiment of the invention provides a liquid crystal display. The liquid crystal display includes a backlight module, a liquid crystal panel, a printed circuit board, and a flexible printed circuit board. The liquid crystal panel is disposed on the backlight module. The liquid crystal panel includes a thin film transistor substrate and a color filter. The color filter faces the backlight module, and the thin film transistor substrate has a bonding area. The flexible printed circuit board connects the bonding area to the printed circuit board. A distance between the color filter and the backlight module is shorter than a distance between the thin film transistor substrate and the backlight module. The backlight module includes a frame, and the thin film transistor substrate is disposed on the frame. The liquid crystal display may further include a cushion disposed between the frame and the thin film transistor substrate. The bonding area is disposed on the frame. The liquid crystal display further includes a front polarizer disposed on the thin film transistor substrate, and a rear polarizer disposed under the color filter. The printed circuit board can be screwed on the frame. The liquid crystal display further includes a metal front casing and a conductive foaming element. The conductive foaming element connects the printed circuit board to the metal front casing. The liquid crystal display optionally includes a pad element disposed between the printed circuit board and the metal front casing or disposed between the printed circuit board and the frame.

Another embodiment of the invention provides a liquid crystal display. The liquid crystal display includes a backlight module, a liquid crystal panel, a printed circuit board, and a flexible printed circuit board. The liquid crystal panel is disposed on the backlight module. The liquid crystal panel includes a thin film transistor substrate and a color filter. The thin film transistor substrate includes a bonding area. The flexible printed circuit board connects the bonding area to the printed circuit board. The printed circuit board, the flexible printed circuit board, and the bonding area are disposed on the same side of the thin film transistor substrate. A distance between the color filter and the backlight module is shorter than a distance between the thin film transistor substrate and the backlight module. The backlight module includes a frame, and the thin film transistor substrate is disposed on the frame. The liquid crystal display may further include a cushion disposed between the frame and the thin film transistor substrate. The bonding area is disposed on the frame. The liquid crystal display further includes a front polarizer disposed on the thin film transistor substrate, and a rear polarizer disposed under the color filter. The printed circuit board can be screwed on the frame. The liquid crystal display further includes a metal front casing and a conductive foaming element. The conductive foaming element connects the printed circuit board to the metal front casing. The liquid crystal display optionally includes a pad element disposed between the printed circuit board and the metal front casing or disposed between the printed circuit board and the frame.

The flexible printed circuit board, the printed circuit board, and the bonding area of the thin film transistor substrate are disposed on the same side of the thin film transistor substrate, such that the flexible printed circuit board does not need to wrap around the thin film transistor substrate. Thus damage to the wires on the flexible printed circuit board caused by friction between the flexible printed circuit board and the thin film transistor substrate can be prevented.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a sectional view of a conventional liquid crystal display;

FIG. 2 is a sectional view of an embodiment of a liquid crystal display of the invention; and

FIG. 3 is a sectional view of another embodiment of a liquid crystal display of the invention.

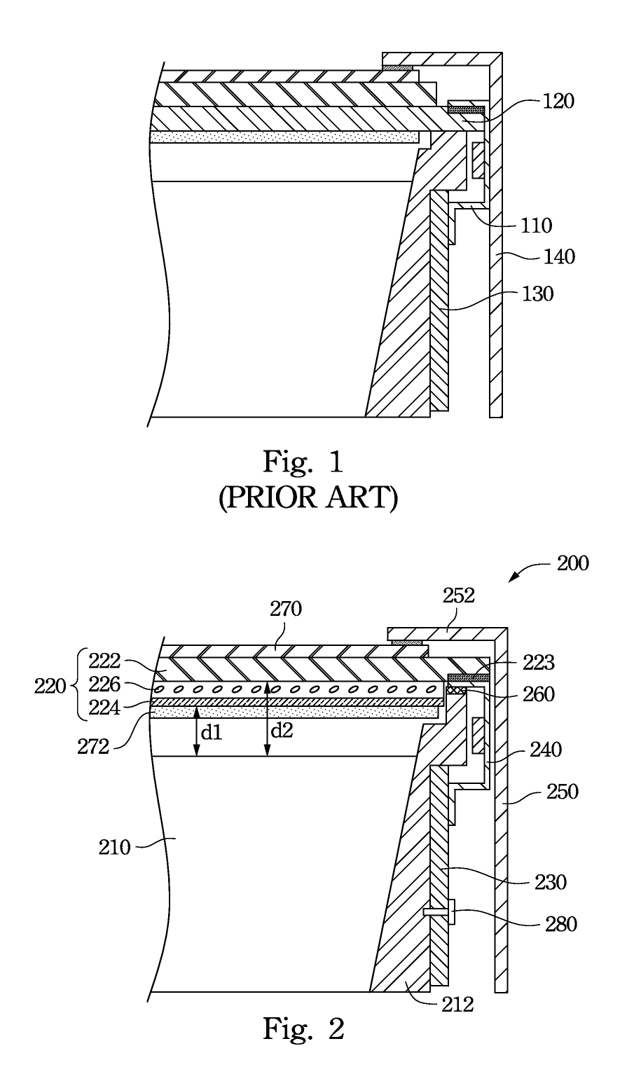

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

FIG. 2 is a sectional view of an embodiment of a liquid crystal display of the invention. The liquid crystal display 200 includes a backlight module 210, a liquid crystal panel 220, a printed circuit board 230, a flexible printed circuit board 240, and a front casing 250. The liquid crystal panel 220 is disposed on the backlight module 210. The liquid crystal panel 220 includes a thin film transistor substrate 222, a color filter 224, and a liquid crystal layer 226 disposed therebetween. The liquid crystal panel 220 is disposed on the backlight module 210 upside down. In particular, the color filter 224 faces the backlight module 210, and is closer to the backlight module 210 than the thin film transistor substrate 222. A distance d1 between the bottom surface of the color filter 224 and the top surface of the backlight module 210 is shorter than a distance d2 between the bottom surface of the thin film transistor substrate 222 and the top surface of the backlight module 210.

The thin film transistor substrate 222 has a bonding area 223. The flexible printed circuit board 240 connects the bonding area 223 to the printed circuit board 230. The printed circuit board 230, the flexible printed circuit board 240, and the bonding area 223 are disposed on the same side of the thin film transistor substrate 222. The width of the thin film transistor substrate 222 is greater than the width of the color filter 224 because of the arrangement of the bonding area 223, thus the thin film transistor substrate 222 is protruded from the color filter 224. Putting the liquid crystal panel 220 upside down can prevent having to wrap the flexible printed circuit board 240 around the thin film transistor substrate 222 (i.e., around the side and upper surfaces of the thin film transistor substrate 222), which may be made of sharp glass. Thus damage to the wires on the flexible printed circuit board 240 resulting from friction between the flexible printed circuit board 240 and the thin film transistor substrate 222 can be prevented.

The backlight module 210 has a frame 212. The liquid crystal panel 220 is disposed on the frame 212. More particularly, the bonding area 223 of the thin film transistor substrate 222 is disposed on the frame 212, and the liquid crystal panel 220 is supported by the frame 212. The liquid crystal display 200 may further include a cushion 260. The cushion 260 is disposed between the frame 212 and the thin film transistor substrate 222 for absorbing shock and preventing the thin film transistor substrate 222 from touching the frame 212 directly and being damaged during assembly. The cushion 260 can be made of an elastic material, such as rubber. The cushion 260 can be coated on the top surface of the frame 212.

The liquid crystal display 200 further comprises a front polarizer 270 and a rear polarizer 272. The front polarizer 270 is disposed on the top surface of the thin film transistor substrate 222. The rear polarizer 272 is disposed on the bottom surface of the color filter 224. The front polarizer 270 is closer to a viewer of the liquid crystal display 200 than the rear polarizer 272.

The printed circuit board 230 can be screwed on the frame 212 of the backlight module 210 with at least one screw 280 or be put on the frame 212 and be fixed by other fix parts. The front casing 250 has a frame side 252. The front casing 250 is fastened on the liquid crystal panel 220 by adhering the frame side 252 on the liquid crystal panel 220. Even though the front casing 250 is close to the liquid crystal panel 220, damage to the flexible printed circuit board 240 and the thin film transistor substrate 222 can be prevented because the flexible printed circuit board 240 does not wrap around the thin film transistor substrate 222. That is, since the flexible printed circuit board 240 does not wrap around the thin film transistor substrate 222, the flexible printed circuit board 240 is not interposed between the thin film transistor substrate 222 and the front casing 250, and as a result, damage to the flexible printed circuit board 240 and the thin film transistor substrate 222 can be prevented. In other embodiments, the printed circuit board 230 can be screwed on a back plate of the backlight module 210.

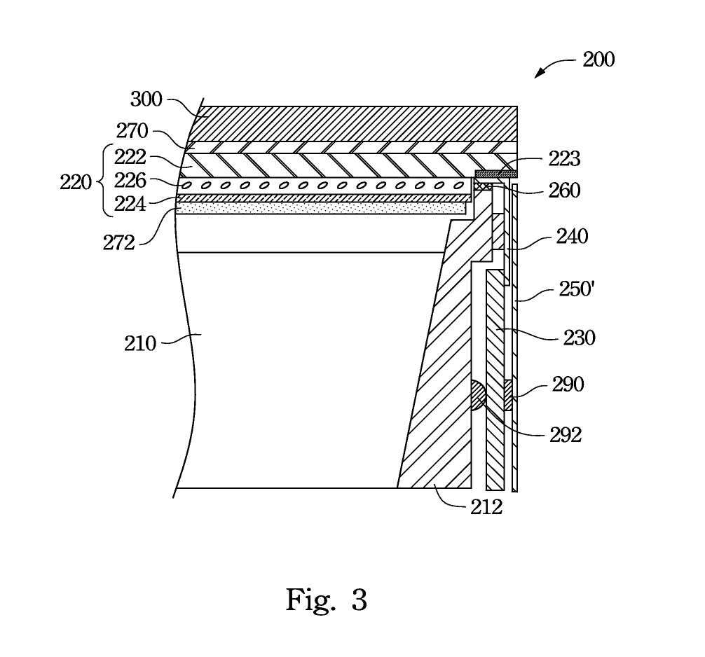

FIG. 3 is a sectional view of another embodiment of the liquid crystal display of the invention. The liquid crystal display 200 includes the backlight module 210, the liquid crystal panel 220, the printed circuit board 230, the flexible printed circuit board 240, and the front casing 250′.

The liquid crystal panel 220 is disposed on the backlight module 210. The liquid crystal panel includes the thin film transistor substrate 222, the color filter 224, and the liquid crystal layer 226 disposed therebetween. The liquid crystal panel 220 is disposed on the backlight module 210 upside down. In particular, the color filter 224 is closer to the backlight module 210 than the thin film transistor 222.

The thin film transistor substrate 222 has the bonding area 223. The flexible printed circuit board 240 connects the bonding area 223 to the printed circuit board 230. The printed circuit board 230, the flexible printed circuit board 240, and the bonding area 223 are disposed on the same side of the thin film transistor substrate 222. The backlight module 210 has the frame 212. The liquid crystal panel 220 is disposed on the frame 212. The cushion 260 is disposed between the frame 212 and the thin film transistor substrate 222. The front polarizer 270 is disposed on the top surface of the thin film transistor substrate 222. The rear polarizer 272 is disposed on the bottom surface of the color filter 224. The front polarizer 270 is closer to a viewer of the liquid crystal display 200 than the rear polarizer 272.

The front casing 250′ is made of a metal material, in this embodiment. The liquid crystal display 200 may further include a conductive foaming element 290. The conductive foaming element 290 connects the printed circuit board 230 to the front casing 250′. The front casing 250′, which is made of a metal material as described above, can be used as a ground for the printed circuit board 230. The liquid crystal display 200 may optionally include a pad element 292. The pad element 292 is disposed between the printed circuit board 230 and the frame 212 for pressing against the printed circuit board 230 so as to ensure the electrical connection to the front casing 250′ via the conductive foaming element 290. In another embodiment, the pad element 292 can be disposed between the front casing 250′ and the printed circuit board 230.

The front casing 250′ can be designed without the frame side (see element 252 in FIG. 2). The liquid crystal panel 220 can be adhered on the front casing 250′. The liquid crystal display 200 may optionally include a touch panel 300. The touch panel 300 is disposed on the top surface of the liquid crystal panel 220 for providing a touch control function.

The flexible printed circuit board, the printed circuit board, and the bonding area of the thin film transistor substrate are disposed on the same side of the thin film transistor substrate, such that the flexible printed circuit board does not need to wrap around the thin film transistor substrate. Thus damage to the wires on the flexible printed circuit board caused by friction between the flexible printed circuit board and the thin film transistor substrate can be prevented.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display comprising:
a backlight module;
a liquid crystal panel disposed on the backlight module, the liquid crystal panel comprising a thin film transistor substrate and a color filter, wherein the color filter faces the backlight module, and the thin film transistor substrate comprises a bonding area;
a printed circuit board; and
a flexible printed circuit board connecting the bonding area to the printed circuit board.

2. The liquid crystal display of claim 1, wherein a distance between the color filter and the backlight module is shorter than a distance between the thin film transistor substrate and the backlight module.

3. The liquid crystal display of claim 1, wherein the backlight module comprises a frame, and the thin film transistor substrate is disposed on the frame.

4. The liquid crystal display of claim 3, further comprising a cushion disposed between the frame and the thin film transistor substrate.

5. The liquid crystal display of claim 3, wherein the bonding area is disposed on the frame.

6. The liquid crystal display of claim 1, further comprising a front polarizer disposed on a top surface of the thin film transistor substrate, and a rear polarizer disposed on a bottom surface of the color filter.

7. The liquid crystal display of claim 1, wherein the backlight module comprises a frame, and the printed circuit board is screwed on the frame.

8. The liquid crystal display of claim 1, further comprising a metal front casing and a conductive foaming element, wherein the conductive foaming element connects the printed circuit board to the metal front casing.

9. The liquid crystal display of claim 8, further comprising a pad element disposed between the printed circuit board and the metal front casing.

10. The liquid crystal display of claim 8, further comprising a pad element, wherein the backlight module comprises a frame, and the pad element is disposed between the printed circuit board and the frame.

11. A liquid crystal display comprising:
a backlight module;
a liquid crystal panel disposed on the backlight module, the liquid crystal panel comprising a thin film transistor substrate and a color filter, wherein the thin film transistor substrate comprises a bonding area;
a printed circuit board; and
a flexible printed circuit board connecting the bonding area to the printed circuit board, wherein the printed circuit board, the flexible printed circuit board, and the bonding area are arranged on the same side of the thin film transistor substrate.

12. The liquid crystal display of claim 11, wherein a distance between the color filter and the backlight module is shorter than a distance between the thin film transistor substrate and the backlight module.

13. The liquid crystal display of claim 11, wherein the backlight module comprises a frame, and the thin film transistor substrate is disposed on the frame.

14. The liquid crystal display of claim 13, further comprising a cushion disposed between the frame and the thin film transistor substrate.

15. The liquid crystal display of claim 13, wherein the bonding area is disposed on the frame.

16. The liquid crystal display of claim 11, further comprising a front polarizer disposed on a top surface of the thin film transistor substrate, and a rear polarizer disposed on a bottom surface of the color filter.

17. The liquid crystal display of claim 11, wherein the backlight module comprises a frame, and the printed circuit board is screwed on the frame.

18. The liquid crystal display of claim 11, further comprising a metal front casing and a conductive foaming element, wherein the conductive foaming element connects the printed circuit board to the metal front casing.

19. The liquid crystal display of claim 18, further comprising a pad element disposed between the printed circuit board and the metal front casing.

20. The liquid crystal display of claim 18, further comprising a pad element, wherein the backlight module comprises a frame, and the pad element is disposed between the printed circuit board and the frame.
